(19) United States
(12) Patent Application Publication
(10) Pub. No.: US 2024/0002265 A1
(43) Pub. Date: Jan. 4, 2024

(54) ELECTRODEIONIZATION DEVICE AND METHOD FOR PRODUCING DEIONIZED WATER

(71) Applicant: ORGANO CORPORATION, Tokyo (JP)

(72) Inventors: Yuki NAKAMURA, Tokyo (JP); Yusuke TAKAHASHI, Tokyo (JP); Keisuke SASAKI, Tokyo (JP)

(73) Assignee: ORGANO CORPORATION, Tokyo (JP)

(21) Appl. No.: 18/039,628

(22) PCT Filed: Oct. 28, 2021
(86) PCT No.: PCT/JP2021/039731

§ 371 Date: May 31, 2023

(30) Foreign Application Priority Data
Dec. 4, 2020 (JP) 2020-201779
Dec. 4, 2020 (JP) 2020-201780

(51) Int. Cl. C02F 1/469

(52) U.S. Cl. CPC C02F 1/4695; C02F 2303/00; C02F 2201/46115; C02F 2101/108

(57) ABSTRACT

An electrodeionization device (EDI device) with improved performance for removing weak acid components such as boron includes a deionization chamber partitioned by a pair of ion exchange membranes between an anode and a cathode. A grain size of 0.1 mm or more and 0.4 mm or less is defined as small grain size, and a grain size of more than 0.4 mm is defined as large grain size. In the deionization chamber, a large grain size layer made of an ion exchange resin of large grain size and a mixed grain size layer in which an ion exchange resin of large grain size and an ion exchange resin of small grain size are mixed are arranged along a flow of water to be treated.

### TECHNICAL FIELD

The present invention relates to an electrodeionization device for producing deionized water from water to be treated which contains weak acid components such as boron, and a method for producing deionized water.

### BACKGROUND ART

There is a demand for removing weak acid components in water to be treated. For example, in recent years, there has been a demand for a further reduction in the content of boron in ultrapure water and the like used in the fabrication of semiconductor devices. Boron in water is a weakly acidic component that is difficult to remove by ion exchange treatment using an ordinary ion exchange resin. As means for removing boron, a reverse osmosis membrane device, a boron-selective ion exchange resin, an electrodeionization (EDI (ElectroDelonization)) device, and the like are known. Of these, the EDI device is a device that combines electrophoresis and electrodialysis, and at least the deionization chamber thereof is filled with an ion exchange resin to generate deionized water from the water to be treated. The EDI device has the advantage that at least the deionization chamber is filled with an ion exchange resin, ion components other than boron can be removed, and there is no need to regenerate the ion exchange resin with chemicals. However, in an EDI device, simply filling the deionization chamber with an ordinary ion exchange resin may not provide sufficient removal performance for weak acid components such as boron. In a such case, two DEI devices may be used by connecting them in series.

Ordinary ion exchange resins have a bead-like or granular shape, and their standard grain size exceeds 0.4 mm and is about 1 mm or less. In order to improve the performance of removing weak acid components such as boron in the EDI device, it has been proposed to fill the deionization chamber with an ion exchange resin having a smaller grain size. For example, Patent Literature 1 discloses that an ion exchange resin having an average grain size of 150 to 250 μm is packed in a single bed in the deionization chamber of an EDI device. Patent Literature 2 discloses packing ion exchange resins with an average diameter of 0.2 to 0.3 mm in a single bed in the deionization chamber. In Patent Literatures 3 and 4, it is disclosed is that. in a deionization chamber in which water to be treated flows vertically, an ion exchange resin having an average grain size of 0.1 to 0.4 mm is filled in the middle region in the vertical direction and the upper and lower regions are filled with an ion exchange resin having an average grain size of more than 0.4 mm.

In order to reduce the electric resistance of the deionization chamber and improve the efficiency of deionization during operation of the EDI device, it is important to control the packing ratio of the ion exchange resin in the deionization chamber. Patent Literature 5 discloses that, in order to reduce electric resistance of the deionization chamber, a plurality of ion exchange resin grain groups of different grain sizes are mixed and filled in the deionization chamber, each ion exchange resin grain group having a uniform grain size.

### CITATION LIST

### Patent Literature

Patent Literature 1: JP 2016-150304 A
Patent Literature 2: JP 2017-176968 A
Patent Literature 3: JP 2019-177327 A
Patent Literature 4: JP 2020-78772 A
Patent Literature 5: JP H10-258289 A

### SUMMARY OF INVENTION

### Technical Problem

When an ion exchange resin with a small grain size is packed in the deionization chamber of an EDI device in order to improve the removal performance of weak acid components such as boron, the gaps between the grains of the ion exchange resin are reduced, resulting in an increase in the differential pressure of water flow. Therefore, the water to be treated must be passed through the deionization chamber at a high pressure, and it is necessary to improve the airtightness of the EDI device. Also, passing the water to be treated under high pressure reduces the durability of the EDI device.

An object of the present invention is to provide an electrodeionization device (EDI device) capable of suppressing an increase in the differential pressure of water flow across a deionization chamber while enhancing the performance of removing weak acid components such as boron, and a method for producing such deionized water.

### Solution to Problem

According to an aspect of the present invention, an electrodeionization device comprising a deionization chamber partitioned by a pair of ion exchange membranes between an anode and a cathode, the deionization chamber being filled with an ion exchange resin, is characterized in that: a grain size of 0.1 mm or more and 0.4 mm or less being defined as small grain size, and a grain size of more than 0.4 mm being defined as large grain size, in the deionization chamber, a large grain size layer made of an ion exchange resin of large grain size and a mixed grain size layer in which an ion exchange resin of large grain size and an ion exchange resin of small grain size are mixed are arranged along a flow of water to be treated.

According to another aspect of the present invention, an electrodeionization device comprising a deionization chamber partitioned by a pair of ion exchange membranes between an anode and a cathode, the deionization chamber being filled with an ion exchange resin, is characterized in that: a grain size of 0.1 mm or more and 0.4 mm or less being defined as small grain size, and a grain size of more than 0.4 mm being defined as large grain size, a mixed grain size layer in which an ion exchange resin of large grain size and an ion exchange resin of the small grain size are mixed with a mixing ratio in which L:S is within a range from 1:1 to 20:1 is arranged in the deionization chamber, L being defined as an apparent volume of the ion exchange resin of large grain size, and S being defined as an apparent volume of the ion exchange resin of the small grain size, and water to be treated containing boron is supplied to the deionization chamber to remove boron from the water to be treated.

According to another aspect of the present invention, a method for producing deionized water to obtain deionized water by passing water to be treated through a deionization chamber which is partitioned by a pair of ion exchange membranes and arranged between an anode and a cathode while applying a DC voltage between the anode and the cathode, is characterized in that: a grain size of 0.1 mm or more and 0.4 mm or less being defined as small grain size, and a grain size of more than 0.4 mm being defined as large grain size, in the deionization chamber, the water to be treated is passed through both a large grain size layer made of an ion exchange resin of the large grain size and a mixed grain size layer in which an ion exchange resin of large grain size and an ion exchange resin of small grain size are mixed.

According to a further aspect of the present invention, a method for producing deionized water to obtain deionized water by passing water to be treated containing boron through a deionization chamber which is partitioned by a pair of ion exchange membranes and arranged between an anode and a cathode while applying a DC voltage between the anode and the cathode, is characterized in that: a grain size of 0.1 mm or more and 0.4 mm or less being defined as small grain size, and a grain size of more than 0.4 mm being defined as large grain size, in the deionization chamber, the water to be treated is passed through a mixed grain size layer in which an ion exchange resin of large grain size and an ion exchange resin of the small grain size are mixed with a mixing ratio in which L:S is within a range from 1:1 to 20:1, to remove boron in the water to be treated, L being defined as an apparent volume of the ion exchange resin of large grain size, and S being defined as an apparent volume of the ion exchange resin of the small grain size.

### Advantageous Effects of Invention

According to the present invention, obtained are an electrodeionization device (EDI device) that suppresses an increase in the differential pressure of water flow across the deionization chamber and enhances the performance of removing weak acid components such as boron, and a method for producing such deionized water.

### BRIEF DESCRIPTION OF DRAWINGS

FIG. 1 is a diagram showing an EDI device according to a first embodiment of the present invention.

FIGS. 2A to 2E are diagrams showing examples of ion exchange resin filling in the deionization chamber.

FIG. 3 is a diagram showing the EDI device according to a second embodiment of the present invention.

FIG. 4 is a diagram showing another example of the EDI device according to the second embodiment.

FIG. 5 is a diagram showing another example of the EDI device according to the second embodiment.

FIG. 6 is a diagram showing another example of the EDI device according to the second embodiment.

FIG. 7 is a diagram showing the EDI device according to a third embodiment of the present invention.

FIG. 8 is a flow diagram showing the configuration of a pure water production system.

FIG. 9 is a diagram showing an EDI device of Comparative Example 1.

FIG. 10 is a diagram showing an EDI device of Comparative Example 2.

FIG. 11 is a graph showing the results of Example 3.

FIG. 12 is a graph showing the results of Example 4.

### DESCRIPTION OF EMBODIMENTS

Next, embodiments of the present invention will be described with reference to the drawings. Generally, in an electrodeionization device (EDI device), a deionization chamber partitioned by a pair of ion exchange membranes is provided between an anode and a cathode, and the deionization chamber is filled with an ion exchange resin. In the EDI device, water to be treated is subjected to desalting (deionization) treatment when the water to be treated is supplied to the deionization chamber in a state in which a DC voltage is applied between the anode and the cathode, and water from which the ion components have been removed is then discharged from the deionization chamber as treated water. Defining a grain size of 0.1 mm or more and 0.4 mm or less as small grain size and defining a grain size of more than 0.4 mm as large grain size, the EDI device according to the present invention is an EDI device in which a mixed grain size layer in which an ion exchange resin of large grain size and an ion exchange resin of small grain size are mixed is arranged in the deionization chamber. By arranging the mixed grain size layer in the deionization chamber of an EDI device, the removal performance of weak acid components including boron is improved. In addition to the mixed grain size layer, a large grain size layer made of an ion exchange resin of large grain size may be arranged in the deionization chamber. When the large grain size layer is arranged, the large grain size layer and the mixed grain size layer are arranged along the flow of the water to be treated in the deionization chamber. Since the grain size of the bead-like or granular ion exchange resin is usually 1 mm or less, the ion exchange resin having a grain size of more than 0.4 mm and 1 mm or less may be used as the ion exchange resin of large grain size. Although the grain size of the ion exchange resin can be measured using a sieve, the catalog value by the manufacturer of the ion exchange resin may be used as the grain size in the present invention. In the present invention, an anion exchange resin of large grain size and an anion exchange resin of small grain size may be mixed to form a mixed grain size layer of the anion exchange resin, or a cation exchange resin of large grain size and a cation exchange resin of small grain size may be mixed to form a mixed grain size layer of the cation exchange resin.

In the present invention, when the weak acid component is mainly boron, the concentration of boron contained in the water to be treated is, for example, 1 ppb or more and 100 ppb or less. Of course, even when the concentration of the weak acid component in the water to be treated is less than 1 ppb or exceeds 100 ppb, the weak acid component in the water to be treated can be removed based on the present invention.

### First Embodiment

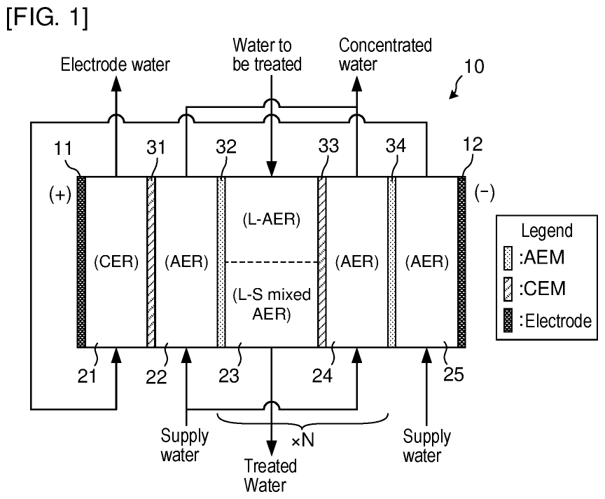

FIG. 1 shows EDI device 10 according to the first embodiment of the present invention. In EDI device 10, between anode chamber 21 equipped with anode 11 and cathode chamber 25 equipped with cathode 12, concentration chamber 22, deionization chamber 23 and concentration chamber 24 are arranged in this order from the side of anode chamber 21. Anode chamber 21 and cathode chamber 25 are collectively called electrode chambers. Anode chamber 21 and concentration chamber 22 are adjacent across cation exchange membrane (CEM) 31; concentration chamber 22 and deionization chamber 23 are adjacent across anion exchange membrane (AEM) 32; deionization chamber 23 and concentration chamber 24 are adjacent across cation exchange membrane 33; and concentration chamber 24 and cathode chamber 25 are adjacent across anion exchange membrane 34. Therefore, deionization chamber 23 is partitioned by a pair of ion exchange membranes between anode 11 and cathode 12. In the example shown here, deionization chamber 23 is partitioned by anion exchange membrane 32 and cation exchange membrane 33. In each figure, the anion exchange membrane (AEM), the cation exchange membrane (CEM) and the electrodes (i.e., anode and cathode) are distinguished by hatching, as indicated in the legend of FIG. 1.

Water to be treated is supplied to deionization chambers 23, and treated water obtained as a result of deionization of the water to be treated, that is, deionized water, flows out from deionization chamber 23. The interior of deionization chamber 23 is filled with an ion exchange resin, and in the example shown here, deionization chamber 23 is filled with an anion exchange resin (AER). The interior of deionization chamber 23 is divided into two regions along the flow of the water to be treated in deionization chamber 23. The region on the inlet side of the water to be treated is filled with an anion exchange resin of large grain size to form a large grain size layer. In the area on the outlet side of the treated water, an ion exchange resin of large grain size and an ion exchange resin of small grain size are mixed and filled to form a mixed grain size layer. In the figure, the large grain size layer made of an anion exchange resin is indicated as “L-AER,” and the mixed grain size layer made of an anion exchange resin is indicated as “LS mixed AER.” In the illustrated example, the boundary between the large grain size layer and the mixed grain size layer is near the center of deionization chamber 23 along the flow direction of the water to be treated.

In EDI device 10, a cation exchange resin (CER) is packed in anode chamber 21, and an anion exchange resin is packed in concentration chambers 22, 24, and cathode chamber 25. Although anode chamber 21, concentration chambers 22, 24, and cathode chamber 25 do not necessarily need to be filled with an ion exchange resin (i.e., an anion exchange resin or a cation exchange resin), it is preferable to fill anode chamber 21, concentration chambers 22, 24 and cathode chamber 25 with ion exchange resins as well, in order to reduce the DC voltage to be applied between anode 11 and cathode 12. Concentration chambers 22, 24 are supplied with supply water for concentration chamber and discharge concentrated water. Supply water for electrode chamber is supplied to cathode chamber 25, and the supply water for electrode chamber supplied to cathode chamber 25 is supplied to anode chamber 21 after passing through cathode chamber 25, and then discharged from anode chamber 21 as electrode water. It should be noted that it can use a configuration which functions as both the concentration chamber and the electrode chamber.

Assuming that the concentration chamber is denoted by “C,” the ion exchange membrane by “M,” and the deionization chamber by “D,” generally in the EDI device, a plurality of basic configurations each consisting of [C|M|D|M|C] can be juxtaposed between an anode and a cathode. At this time, two concentration chambers adjacent to each other with an ion exchange membrane interposed therebetween can be made into a single concentration chamber by removing the sandwiched ion exchange membrane. In EDI device 10 shown in FIG. 1, assuming that anion exchange membrane 32, deionization chamber 23, cation exchange membrane 33 and concentration chamber 24 form one basic configuration, N sets of such basic configurations can be arranged between concentration chamber 22 closest to anode chamber 21 and anion exchange membrane 34 in contact with cathode chamber 25, where N is an integer of 1 or more. The fact that a plurality of basic configurations can be arranged side by side is indicated by indication “×N” in the figures.

Next, production of the deionized water (i.e., treated water) by EDI device 10 shown in FIG. 1 will be described. As in the case of a general EDI device, the water to be treated is passed through deionization chamber 23 in a state that supply water for concentration chamber is supplied to concentration chambers 22, 24, supply water for electrode chamber is supplied to cathode chamber 25, anode chamber 21 is also supplied with the supply water for electrode chamber, and a DC voltage is applied between anode 11 and cathode 12. As a result, ion components in the water to be treated are adsorbed by the ion exchange resin in deionization chambers 23 to proceed with deionization (desalting), and deionized water flows out from deionization chamber 23 as treated water. The water to be treated first passes through the large grain size layer in deionization chamber 23, where strong acid components and weak acid components that are relatively easily adsorbed by the anion exchange resin are removed from the water to be treated. Components such as boron contained in the water to be treated that are relatively difficult to remove are removed from the water to be treated by being adsorbed by the anion exchange resin when subsequently passing through the mixed grain size layer containing the anion exchange resin with small grain size. As a result, the treated water from which weak acid components such as boron have been sufficiently removed is discharged from deionization chamber 23. The mixed grain size layer has a higher water flow resistance than the large grain size layer. However, in EDI device 10 of the present embodiment, since deionization chamber 23 is not entirely formed of the mixed grain size layer and the large grain size layer also exists. the increase in the differential pressure of water flow is within an acceptable range when the water to be treated passes through deionization chamber 23.

In EDI device 10 of the present embodiment, the order of arrangement of the large grain size layer and the mixed grain size layer along the direction of flow of the water to be treated is arbitrary. One large grain size layer and one mixed grain size layer may be provided, or two or more layers of at least one of the large grain size layer and the mixed grain size layer may be provided. However, since the configuration it is preferable to initially remove components that are relatively easy to remove in the water to be treated and then remove components that are relatively difficult to remove, it is preferable that the mixed grain size is arranged near the outlet of the treated water in deionization chamber 23. In this case, the mixed grain size layer may be arranged so as to be in contact with the outlet of the treated water, or at least a portion of the mixed grain size layer may be included in a region within 25% of the length of deionization chamber 23 along the flow of the water to be treated from the outlet of the treated water. Both the mixed grain size layer and the large grain size layer are arranged in deionization chamber 23, and it is preferable that the ratio of the mixed grain size layer among them is such that, for example, a total filling height of the ion exchange resin along the flow of the water to be treated in the mixed grain size layer is 20% or more and 80% or less of a length of deionization chamber 23 along the flow of the water to be treated. If the ratio of the mixed grain size layer is too small, the removal performance of the weak acid components including boron is lowered. If the ratio of the mixed grain size layer is too large, the differential pressure of water flow in deionization chamber 23 becomes large. As will be described later, when the purpose is to remove particularly boron among the weak acid components, deionization chamber 23 may be configured without the large grain size layer. In this Description, the filling height of the ion exchange resin along the flow of the water to be treated in the large grain size layer or the mixed grain size layer is sometimes referred to as the filling height of that layer. The length of deionization chamber 23 means the length of deionization chamber 23 along the flow of the water to be treated which is the length of the portion of deionization chamber 23 where the ion exchange resin is provided.

Weak acid components in the water to be treated are adsorbed by the anion exchange resin forming the mixed grain size layer by ion exchange, and then pass through anion exchange membrane 32 as anions and move to concentration chamber 22 on the side of anode 11. Since the lower the anion concentration in concentration chamber 22, the easier the weak acid component moves to concentration chamber 22, a low anion concentration is preferred in water flowing through a position of concentration chamber 23 which is opposed to the mixed grain size layer of deionization chamber 23 via anion exchange membrane therebetween. Further, as described above, it is preferable that the mixed grain size layer is provided at a position close to the outlet in deionization chamber 23. For these reasons, it is preferable that the flow of the outlet water in deionization chamber 23 and the flow of supply water supplied to concentration chamber 22 are countercurrent.

The mixing ratio of the ion exchange resin of large grain size and the ion exchange resin of small grain size in the mixed grain size layer will be described. Since the ion exchange resin is in the form of beads or granules regardless of whether the grain size is large or small, the apparent volume including voids between grains can be measured. The mixing ratio L:S is preferably between 1:1 and 20:1, and more preferably between 5:1 and 10:1, where L is the apparent volume of the ion exchange resin of large grain size before mixing, and S is the apparent volume of the ion exchange resin of small grain size. If the ratio of the ion exchange resin of large grain size is too high, sufficient performance for removing weak acid components such as boron cannot be obtained, and if the ratio of the ion exchange resin of small grain size is too high, the differential pressure of water flow increases. Even after the mixed grain size layer is formed by mixing the ion exchange resin of large grain size and the ion exchange resin of small grain size, the mixing ratio of the ion exchange resin of large grain size and the ion exchange resin of small grain size can be determined. For example, the mixed grain size layer is taken out from deionization chamber 23 and classified using a sieve and separated into ion exchange resins having a grain size of 0.1 mm or more and 0.4 mm or less and ion exchange resins having a grain size of more than 0.4 mm. By separating and measuring the apparent volume of each, the mixing ratio L:S can be determined.

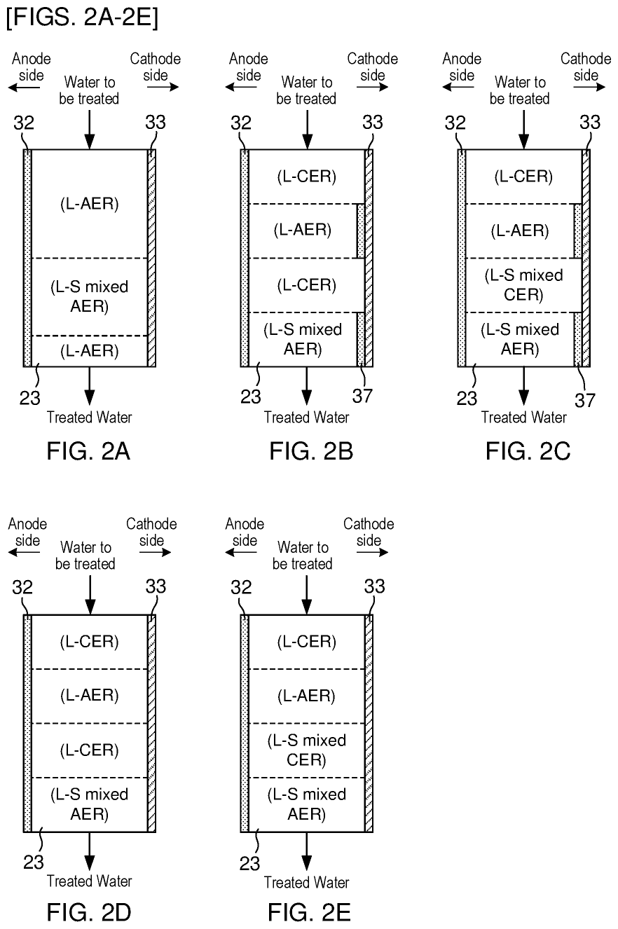

In EDI device 10 shown in FIG. 1, the large grain size layer of anion exchange resin is disposed in deionization chamber 23 on its inlet side, and the mixed grain size layer of anion exchange resin is disposed in deionization chamber 23 on its outlet side. As is clear from the above description, the arrangement of the ion exchange resins in deionization chamber 23 is not limited to that shown in FIG. 1. FIGS. 2A to 2E show other examples of the arrangement of the ion exchange resins in deionization chamber 23 by extracting and drawing only deionization chamber 23 and the ion exchange membranes on both sides thereof. In the example shown in FIG. 2A, a large grain size layer is arranged with a smaller filling height in contact with the outlet of deionization chamber 23 and the mixed grain size layer is sandwiched between another large grain layer on the inlet side of deionization chamber 23 and the large grain size layer on the outlet side thereof, in deionization chamber 23 of EDI devices 10 shown in FIG. 1. In the example shown in FIG. 2A, the filling height of the mixed grain size layer is about 36% of the length of deionization chamber 23, and the filling height of the large grain size on the outlet side is about 14% of the length of deionization chamber 23.

In addition to the anion exchange resin, deionization chamber 23 may be filled with a cation exchange resin (CER) to remove ionic impurities that are cations. In the example shown in FIG. 2B, in deionization chamber 23, a large grain size layer of a cation exchange resin, a large grain size layer of an anion exchange resin, another large grain size layer of a cation exchange resin and a mixed grain size layers made of an anion exchange resin are arranged in this order from the inlet side. In the figure, the large grain size layer made of a cation exchange resin is indicated as “L-CER.” The fill height of each layer is approximately the same. In the example shown in FIG. 2B, anion exchange membrane 37 is arranged to the interface between cation exchange membrane 33 and the anion exchange resin in deionization chamber 23 in order to promote the dissociation reaction of water on the side of cathode 12 of the anion exchange resin.

Deionization chamber 23 shown in FIG. 2C is one obtained by replacing the large grain size layer on the outlet side among two large grain size layers made of a cation exchange resin in deionization chamber 23 shown in FIG. 2A with a mixed grain size layer of a cation exchange resin. Anion exchange membrane 37 provided in contact with cation exchange membrane 33 may not necessarily be provided. In the figure, the mixed grain size layer composed of a cation exchange resin is indicated as “L-S mixed CER.” The configurations shown in FIGS. 2D and 2E are ones in which anion exchange membrane 37 is removed form the configurations shown in FIGS. 2B and 2C, respectively. In the configurations shown in FIGS. 2D and 2E, the anion exchange resin is contact with cation exchange membrane 33 on the side of cathode 12 thereof. In the present invention, either an anion exchange resin or a cation exchange resin may be used for the mixed grain size layer. When it is intended to remove weak acid components such as boron, it is preferable to provide at least one of a large grain size layer of an anion exchange resin and a mixed grain size layer of an anion exchange resin in deionization chamber 23, and more preferably to provide the mixed grain size layer made of an anion exchange resin.

### Second Embodiment

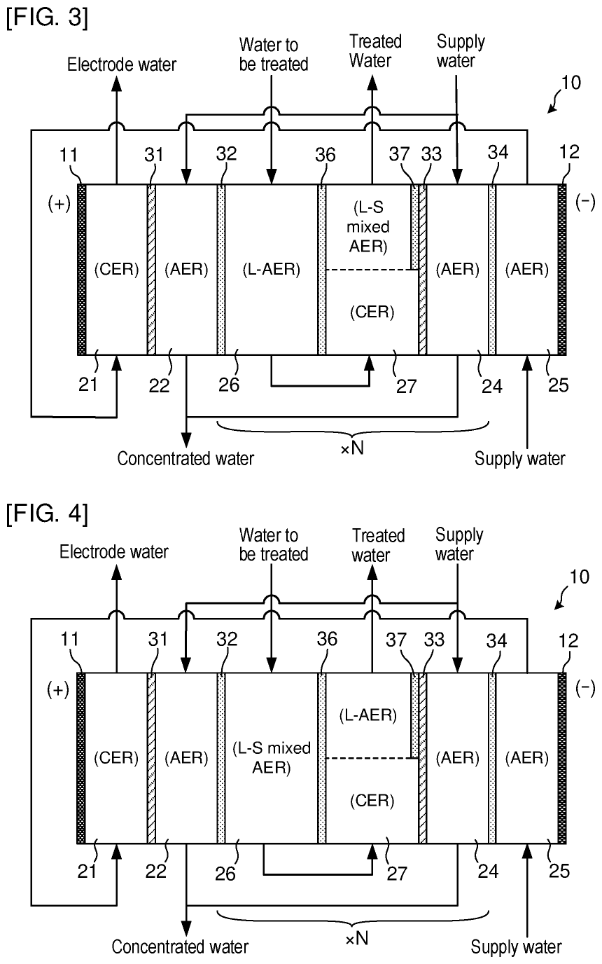

The EDI device according to the present invention may be configured such that the deionization chamber itself is divided into two small deionization chambers by an ion exchange membrane, the water to be treated is supplied to one of the small deionization chambers, and the water flowing out from the one small deionization chamber is then supplied to the other small deionization chamber. Deionized water is obtained as the treated water from the other small deionization chamber. EDI device 10 of the second embodiment of the present invention shown in FIG. 3 is one in which deionization chamber 23 in EDI device 10 shown in FIG. 1 is partitioned into two small deionization chambers 26, 27 by anion exchange membrane 36, which is an intermediate ion exchange membrane, and the arrangements of ion exchange resins in the small deionization chambers are made different. First small deionization chamber 26 is arranged on the side closer to anode 11 with anion exchange membrane 36 interposed therebetween, and second small deionization chamber 27 is arranged on the side closer to cathode 12. The water to be treated is supplied to first small deionization chamber 26, and the outlet water from first small deionization chamber 26 is supplied to second small deionization chamber 27. The outlet water from second small deionization chamber 27 is the treated water (i.e., deionized water) from EDI device 10. When the deionization chamber is divided into first small deionization chamber 26 on the inlet side and second small deionization chamber 27 on the outlet side, the length of the deionization chamber means the sum of a length of a portion of first small deionization chamber 26 in which an ion exchange resin is arranged and a length of a portion of second small deionization chamber 27 in which an ion exchange resin is arranged, along the flow of the water to be treated.

In EDI device 10 shown in FIG. 3, the direction of flow in first small deionization chamber 26 and the direction of flow in second small deionization chamber 27 are opposite to each other, that is, countercurrent. The direction of flow in concentration chamber 22 on the side of anode 11 is the same as the direction of flow in the adjacent first small deionization chamber 26, and both are in a parallel flow relationship. The direction of flow in second small deionization chamber 27, which is the outlet side of the deionization chamber, and the direction of flow in concentration chamber 24 adjacent thereto are in a countercurrent relationship. First small deionization chamber 26 is filled with an anion exchange resin as a large grain size layer. In second small deionization chamber 27, the inlet side is filled with a cation exchange resin, and the outlet side is filled with an anion exchange resin as a mixed grain size layer. The cation exchange resin is usually provided as a large grain size layer, but may be provided as a mixed grain size layer. The boundary between the mixed grain size layer of the anion exchange resin and the cation exchange resin in second small deionization chamber 27 is approximately half the length of second small deionization chamber 27, in other words, at a position of about 25% of the length of the deionization chamber measured from the outlet side of the deionization chamber. Anion exchange membrane 37 is provided at the interface where cation exchange membrane 33 and the anion exchange resin in second small deionization chambers 27 contact each other. The anion exchange resin in second small deionization chambers 27 may be in direct contact with cation exchange membrane 33 without providing anion exchange membrane 37. In EDI device 10 shown in FIG. 3 as well, since the water to be treated passes through the mixed grain size layer of the anion exchange resin, it is possible to efficiently remove weak acid components such as boron. Moreover, since there is also a large grain size layer made of at least an anion exchange resin, it is possible to suppress an increase in the differential pressure of water flow.

Also in the second embodiment in which the deionization chamber is divided into two small deionization chambers by an intermediate ion exchange membrane, the preferred mixing ratio of the ion exchange resin of large grain size and the ion exchange resin of small grain size in the mixed grain size layer and the preferred ratio of the total filling height of the mixed grain size layer to the length of the deionization chamber are the same as those described in the first embodiment. Also in the second embodiment, it is preferable to provide the mixed grain size layer at a position close to the outlet of the treated water in the entire deionization chamber. At least a portion of the mixed grain size layer may be included within a range of 25% of the length of the deionization chamber from the outlet of the treated water.

FIG. 4 shows another configuration example of the EDI device of the second embodiment. EDI device 10 shown in FIG. 4 is one in which, in EDI device 10 shown in FIG. 3, the anion exchange resin filled in first small deionization chamber 26 is made into a mixed grain size layer and the anion exchange resin filled in second small deionization chamber 27 is made into a large grain size layer instead.

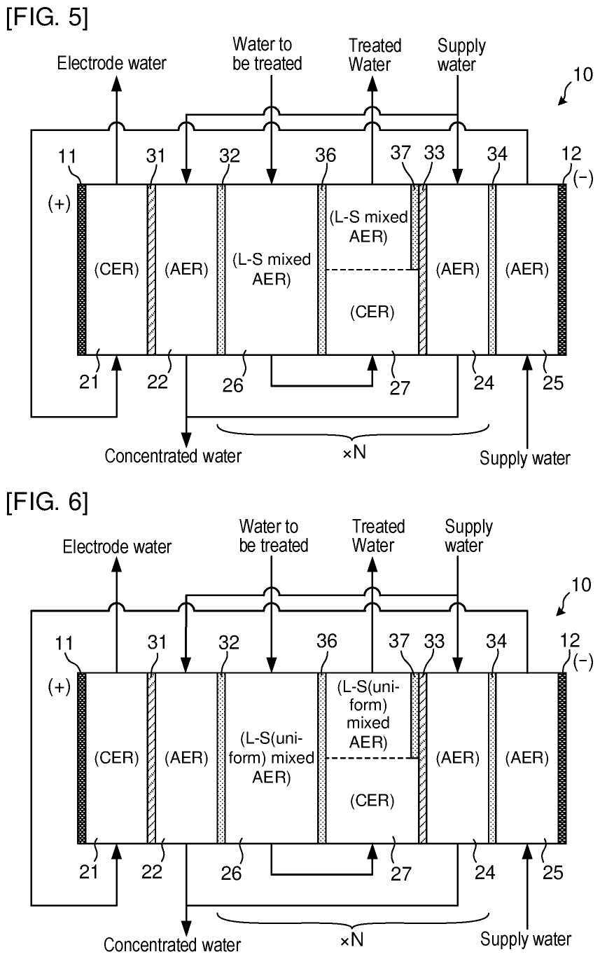

FIG. 5 shows still another configuration example of the EDI device of the second embodiment. EDI device 10 shown in FIG. 5 is one in which, in EDI device 10 shown in FIG. 3, the anion exchange resin filled in first small deionization chambers 26 is made into a mixed grain size layer. In this EDI device 10, the cation exchange resin filled in the second small deionization chambers 27 is made into a large grain size layer.

FIG. 6 shows still another configuration example of the EDI device of the second embodiment. EDI device 10 shown in FIG. 6 is one in which, in EDI device 10 shown in FIG. 5, a mixture of an anion ion exchange resin of large grain size and an anion ion exchange resin of small grain size having a uniform grain size is used for the anion exchange resins which are packed in first small deionization chamber 26 and second deionization chamber 27 as the mixed grain size layers. In the figure, the mixed grain size layer composed of the anion exchange resin which uses an anion exchange resin having a uniform grain size as the ion exchange resin of small grain size is indicated as “L-S (uniform) mixed AER.” Uniform grain size means that the grains of the ion exchange resin have a small variation in grain size, for example, a uniformity coefficient of 1.2 or less. The uniformity coefficient is obtained by measuring the grain size of the ion exchange resin by sieving, plotting the state of normal distribution as a straight line on a logarithmic probability graph, and determining sieve openings corresponding to 90% and 40% of cumulative residual percentages on the sieve. When the sieve opening corresponding to 90% is taken as the effective diameter, the uniformity coefficient is defined as the ratio between the sieve opening corresponding to 40% and the effective diameter. Millimeters (mm) are used as the unit of the sieve opening. The theoretical minimum value of the uniformity coefficient is 1, and it can be said that the closer to 1, the more uniform the grain size. As will become clear from Examples described later, the removal rate of the weak acid component is improved by using an anion exchange resin having a uniform grain size as the anion exchange resin of small grain size in the mixed grain size layer.

### Third Embodiment

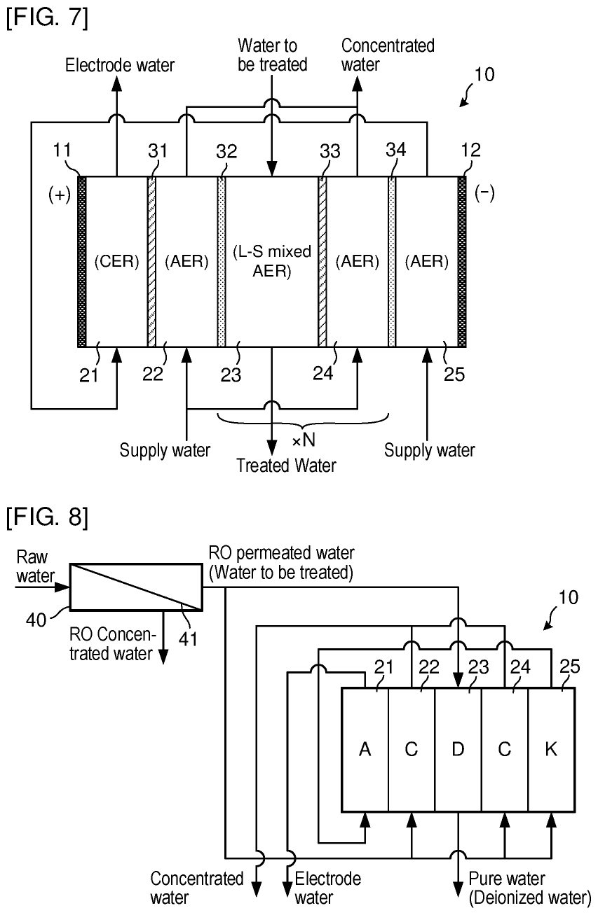

FIG. 7 shows the configuration of EDI device 10 according to a third embodiment of the invention. EDI device 10 shown in FIG. 7 is suitable for removing boron from water to be treated containing boron. The concentration of boron in the water to be treated is, for example, 1 ppb or more and 100 ppb or less. EDI device 10 shown in FIG. 7 is similar to EDI device 10 shown in FIG. 1, but differs from that shown in FIG. 1 in that only a mixed grain size layer made of an anion exchange resin is provided. Furthermore, in the mixed grain size layer filled in deionization chamber 23, the anion exchange resin of large grain size and the anion exchange resin of small grain size are mixed at a mixing ratio L:S within the range of 1:1 to 20:1.

Next, production of deionized water by EDI device 10 shown in FIG. 7 will be described. As in the case of EDI devices 10 of the first and second embodiments, water to be treated containing boron is passed through deionization chamber 23 in the state in which supply water is passed through concentration chambers 22, 24, cathode chamber 25 and anode chamber 21, and a DC voltage is applied between anode 11 and cathode 12. Then, deionization, in which ion components in the water to be treated are adsorbed by the ion exchange resin in deionization chamber 23, progresses, and deionized water flows out from deionization chamber 23 as treated water. At this time, boron contained in the water to be treated is also removed. When an anion exchange resin of large grain size is used alone, it is difficult to efficiently remove boron by adsorption. In EDI device 10 of the present embodiment, the mixed grain size layer containing an anion exchange resin of small grain size is provided in deionization chamber 23, and boron in the water to be treated is efficiently adsorbed by the anion exchange resin of small grain size in the mixed grain size layer and removed from the water to be treated. As a result, the treated water containing little boron flows out of deionization chamber 23. Boron can be removed even when deionization chamber 23 is filled only with an anion exchange resin of small grain size. In such a case, differential pressure of water flow in deionization chamber 23 increases greatly, as will become clear from Examples described later. In the present embodiment, by filling deionization chamber 23 with the anion exchange resin as a mixed grain size layer in which an anion exchange resin of large grain size and an anion exchange resin of small grain size are mixed, an increase in the differential pressure of water flow in deionization chamber 23 can be suppressed while the removal efficiency of boron is improved.

The EDI devices according to the present invention has been described above. The EDI device can be used, for example, when pure water or ultrapure water is produced from raw water. FIG. 8 is a flow diagram showing the configuration of a pure water production system using EDI device 10 described above. The Electrodes and the ion exchange membranes are not drawn in this figure. Also, although this figure is drawn as if EDI device 10 of the first or third embodiment is used, it is also possible to use EDI device 10 of the second embodiment. A reverse osmosis (RO) membrane device to which raw water is supplied is provided, and reverse osmosis membrane 41 is provided inside reverse osmosis membrane device 40. The water that has not permeated reverse osmosis membrane 41 in reverse osmosis membrane device 40, that is, RO concentrated water, contains many impurities, and the RO concentrated water is blown to the outside. The water that permeates reverse osmosis membrane 41 in reverse osmosis membrane device 40, that is, RO permeated water, is water containing relatively no impurities, and is supplied to deionization chamber (D) 23 of EDI device 10 as the water to be treated. A portion of the RO permeated water is supplied to concentration chambers (C) 22, 24 and cathode chamber (K) 25 as supply water for concentration chambers and supply water for electrode chamber. Water discharged from cathode chamber 25 is subsequently supplied to anode chamber (A) 21. The electrode water discharged from anode chamber 21 is blown to the outside, and the concentrated water discharged from concentration chambers 22 and 24 is also blown to the outside.

By applying a DC voltage between the anode (not shown in FIG. 8) provided in anode chamber 21 and the cathode (not shown in FIG. 8) provided in cathode chamber 25, and supplying the RO permeated water to deionization chamber 23 as the water to be treated, deionization treatment is performed in deionization chamber 23, and pure water flows out from deionization chamber 23 as deionized water, which is the treated water. Weak acid components, particularly boron, contained in the raw water easily pass through reverse osmosis membrane 41 and are easily contained in the RO permeate water. When an EDI device is provided at the subsequent stage of the reverse osmosis membrane device to remove boron or the like, the conventional EDI device does not have sufficient performance for removing boron, so the EDI device may be connected in two stages. By using EDI device 10 of each of the above embodiments, boron in the water to be treated can be sufficiently removed only by providing one stage of EDI device 10 at the subsequent stage of reverse osmosis membrane device 40.

As described above, according to the EDI device according to the present invention, by arranging, in deionization chamber, the mixed grain size layer in which an ion exchange resin of large grain size and an ion exchange resin of small grain size are mixed, it is possible to improve the removal rate of weak acid components such as boron, and to obtain pure water and ultrapure water of higher water quality. An improvement in the removal rate of weak acid components in an EDI device leads achievement of the miniaturization of a device such as a reverse osmosis membrane device installed in the preceding stage of the EDI device, and the miniaturization of a device, such as ion exchange device, which may be installed in the subsequent stage of the EDI device.

### EXAMPLES

The present invention will be described in more detail below using Examples and Comparative Examples. In the following description, the mixing ratio when forming a mixed grain size layer by mixing an ion exchange resin of large grain size and an ion exchange resin of small grain size is expressed as L:S. L is the apparent volume of the ion exchange resin of large grain size before mixing, and S is the apparent volume of the ion exchange resin of small grain size before mixing.

### Example 1

As the EDI device of Example 1, EDI device 10 shown in FIG. 7 was assembled. In Example 1, it was confirmed the removal rate of boron, which is a weak acid component, becomes high when the anion exchange resin arranged in the deionization chamber is made into a mixed grain size layer in comparison with the case where a large grain size layer of an anion exchange resin is used. A frame-shaped cell having an opening of 10 cm×10 cm and a thickness of 1 cm was used for each of anode chamber 21, concentration chambers 22, 24, deionization 23 and cathode chamber 25. The EDI device was constructed by filling the cell of each chamber with an ion exchange resin and stacking these cells in the thickness direction with an ion exchange membrane interposed therebetween. As the cation exchange resin (CER), AMBERJET® 1020 manufactured by DuPont was used and filled in anode chamber 21. This cation exchange resin had a grain size of 0.60 to 0.70 mm and a uniformity coefficient of 1.20 or less. As the anion exchange resin (AER) of large grain size, AMBERJET® 4002 manufactured by DuPont was used. The grain size of this anion exchange resin of large grain size was 0.50 to 0.65 mm, and the uniformity coefficient was 1.20 or less. As the anion exchange resin of small grain size, DOWEX® 1×4 50-100 mesh anion exchange resin, manufactured by DuPont, was used. The grain size of this anion exchange resin of small grain size was 0.15 to 0.3 mm, and the uniformity coefficient was 1.3 or less. The anion exchange resin of large grain size and the anion exchange resin of small grain size were mixed so that a mixing ratio L:S was 10:1, and filled in deionization chamber 23 as the mixed grain size layer. Concentration chamber 22, 24 and cathode chamber 25 were also filled with the above-mentioned anion exchange resin of large grain size.

Permeate water which was obtained by permeating raw water through two stages of reverse osmosis membrane devices and was added with boric acid so that the boron concentration was 50 ppb was used as the water to be treated supplied to deionization chamber 23. The electrical conductivity of the water to be treated was 0.3 to 0.4 μS/cm. The water to be treated was passed through deionization chamber 23 at a flow rate of 30 L/h. The permeated water obtained by permeating the raw water through two stages of reverse osmosis membrane devices was used as the supply water, and was supplied to each of concentration chambers 22, 24 at a flow rate of 10 L/h, and supplied to cathode chamber 25 at 5 L/h. A DC voltage was applied between anode 11 and cathode 12 so that the current was 0.5 A, and operated the EDI device. Then, the concentration of boron in the outlet water of deionization chamber 23, that is, the treated water was measured, and the boron removal rate by the EDI device was found to be 96.2%.

### Comparative Example 1

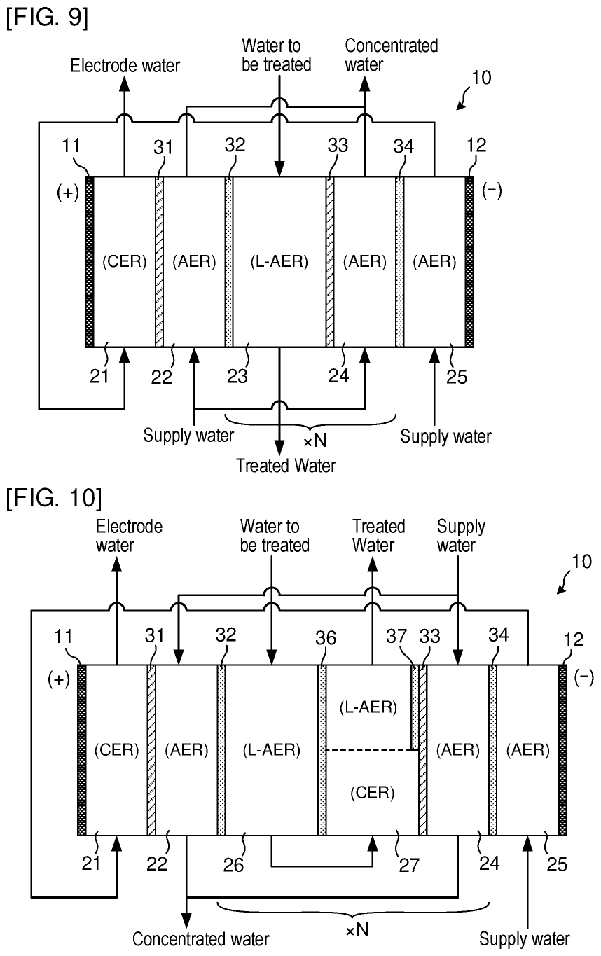

As the EDI device of Comparative Example 1, EDI device 10 shown in FIG. 9 was assembled. The EDI device shown in FIG. 9 is one in which, in the EDI apparatus of Example 1, the entire anion exchange resin filled in deionization chamber 23 is made into a large grain size layer. The cells used, the cation exchange resin used, and the anion exchange resin of large grain size used were all the same as those in Example 1, and water was passed through the completed EDI device under the same conditions as in Example 1, and a DC voltage was applied. Then, the boron concentration in the treated water was measured. Based on this measurement, the boron removal rate of the EDI device was determined to be 95%.

From the results of Example 1 and Comparative Example 1, it was found that the removal rate of boron was improved by making the anion exchange resin filled in deionization chamber 23 into the mixed grain size layer.

### Example 2-1

EDI device 10 shown in FIG. 3 above was assembled. The frame-shaped cells used in Example 1 were used for each of anode chamber 21, concentration chambers 22, 24, cathode chamber 25, first small deionization chamber 26, and second small deionization chamber 27. The EDI device was constructed by stacking cells in the same manner as in Example 1. The same cation exchange resin (CER), anion exchange resin (AER) of large grain size, and anion exchange resin of small grain size as used in Example 1 were used. Concentration chambers 22, 24 and cathode chamber 25 were also filled with the anion exchange resin of large grain size, and the cation exchange resin was also filled into anode chamber 21. The anion exchange resin of large grain size and the anion exchange resin of small grain size were mixed at a mixing ratio of 10:1, and were was filled on the outlet side of second small deionization chamber 27 as the mixed grain size layer.

Permeate water which was obtained by permeating raw water through two stages of reverse osmosis membrane devices and added with boric acid so that the boron concentration was 50 ppb was used as the water to be treated supplied to first small deionization chamber 26. The electrical conductivity of the water to be treated was 0.3 to 0.4 μS/cm. The water to be treated was passed through deionization chamber 23 at a flow rate of 30 L/h. Permeated water obtained by permeating raw water through two stages of reverse osmosis membrane devices was supplied as supply water to each of concentration chambers 22, 24 at a flow rate of 10 L/h and to cathode chamber 25 at 5 L/h. A DC voltage was applied between anode 11 and cathode 12 so that the current was 0.5 A, and operated the EDI device. Then, the boron concentration in the outlet water of second small deionization chamber 27, that is, the treated water, was measured. In addition, the pressure of the water to be treated at the inlet of first small deionization chamber 26 and the pressure of the treated water at the outlet of second small deionization chamber 27 were measured, and the difference between them was calculated to obtain the differential pressure of water flow. The results are shown in Table 1.

### Example 2-2

As the EDI device of Example 2-2, EDI device 10 shown in FIG. 4 was assembled. Specifically, the EDI device of Example 2-2 was assembled by using the same cells as in Example 2-1, filling first small deionization chambers 26 with the anion exchange resin as a mixed grain size layer, and filling the outlet side of second small deionization chambers 27 with the anion exchange resin as a large grain size layer. In this EDI device, the same anion exchange resins of large grain size and small grain size and cation exchange resin as used in Example 2-1 were used. The mixing ratio of the anion exchange resin of large grain size and the anion exchange resin of small grain size in the mixed grain size layer was also the same as in Example 2-1. Then, the EDI apparatus was operated in the same manner as in Example 2-1 to obtain the boron removal rate and the differential pressure of water flow. The results are shown in Table 1.

### Example 2-3

As the EDI device of Example 2-3, EDI device 10 shown in FIG. 5 was assembled. Specifically, the EDI device of Example 2-3 was assembled by using the same cells as in Example 2-1 and filling first small deionization chamber 26 with an anion exchange resin as a mixed grain size layer. In this EDI device, the same anion exchange resins of large grain size and small grain size and cation exchange resin as used in Example 2-1 were used. The mixing ratio of the anion exchange resin of large grain size and the anion exchange resin of small grain size in the mixed grain size layer was also the same as in Example 2-1. Then, the EDI apparatus was operated in the same manner as in Example 2-1 to obtain the boron removal rate and the differential pressure of water flow. The results are shown in Table 1.

### Example 2-4

As the EDI device of Examples 2-4, EDI device 10 shown in FIG. 6 was assembled. Specifically, the EDI device of Example 2-4 is similar to the EDI device of Example 1-3. However, the EDI device of Example 2-4 differs from the EDI device of Example 2-3 in that as an anion exchange resin having a uniform grain size was used as an anion exchange resin of small grain size which was used in the mixed grain size layer of anion exchange resin filled in the first small deionization chamber 26 and second small deionization chamber 27. Specifically, DOWEX® 1×4 50-100 mesh anion exchange resin manufactured by DuPont with a grain size of 0.15 to 0.3 mm and a uniformity factor of 1.3 or less was used, and, by separating this anion exchange resin with a sieve, only grains having a grain size of about 0.3 mm were taken out. Then, the grains thus obtained were used as an anion exchange resin having a small grain size and a uniform grain size, which constituted the mixed grain size layer. At this time, the uniformity coefficient of the anion exchange resin of small grain size constituting the mixed grain diameter layer was 1.15. In addition, the mixing ratio L:S of the anion exchange resin of large grain size and the anion exchange resin of small grain size in the mixed grain size layer was set to 5:1. Then, the EDI device was operated in the same manner as in Example 2-1 to obtain the boron removal rate and the differential pressure of water flow. The results are shown in Table 1.

### Comparative Example 2

As the EDI device of Comparative Example 2, EDI device 10 shown in FIG. 10 was assembled. This EDI device 10 is one in which. in EDI device 10 of Example 2-1, the anion exchange resin filled in second small deionized chamber 27 was made into a large grain size layer. In this EDI device, the same anion exchange resin of large grain size and cation exchange resin as used in Example 2-1 were used. Then, the EDI device was operated in the same manner as in Example 2-1 to obtain the boron removal rate and the differential pressure of water flow. The results are shown in Table 1.

TABLE 1

| | | | Removal | Differential |
|---|---|---|---|---|
| | Configuration of anion exchange resin | | rate of | pressure of |
| | First small | Second small | boron | water flow |
| | deionization chamber | deionization chamber | [%] | [MPa] |
| Comparative | Large grain size AER | Large grain size AER | 99.2 | 0.18 |
| Example 2 | | | | |
| Example | Large grain size AER | Mixture of large grain | 99.4 | 0.18 |
| 2-1 | | size AER and small | | |
| | | grain size AER | | |
| Example | Mixture of large grain | Large grain size AER | 99.2 | 0.18 |
| 2-2 | size AER and small | | | |
| | grain size AER | | | |
| Example | Mixture of large grain | Mixture of large grain | 99.4 | 0.2 |
| 2-3 | size AER and small | size AER and small | | |
| | grain size AER | grain size AER | | |
| Example | Mixture of large grain | Mixture of large grain | 99.6 | 0.2 |
| 2-4 | size AER and small | size AER and small | | |
| | grain size (uniform | grain size (uniform | | |
| | grain size) AER | grain size) AER | | |

From Table 1 as well, it was found that the boron removal performance was improved by providing an EDI device with a mixed grain size layer in which an anion exchange resin of large grain size was mixed with an anion exchange resin of small grain size. By using an anion exchange resin having a uniform grain size as the anion exchange resin of small grain size contained in the mixed grain size layer, the removal rate of boron was further improved. Further, by arranging the mixed grain size layer on the outlet side of the flow of the water to be treated in the deionization chamber, in the example shown here, by arranging the mixed grain size layer in the second small deionization chamber, boron removal performance is improved furthermore. There is concern about an increase in the differential pressure of water flow when an ion exchange resin of large grain size is mixed with an ion exchange resin of small grain size. However, it was found that, when the mixing ratio L:S is 5:1 or the ratio of the anion exchange resin of large grain size was higher than that, the differential pressure of water flow was almost the same as the case in which only the anion exchange resin of large grain size was used, and that the increase in the differential pressure of water flow could be suppressed. From Table 1, it can be seen that by forming the mixed grain size layer of the anion exchange resin in the area of 25% of the length of the deionization chamber from the outlet side of the deionization chamber, it is possible to achieve improvement of boron removal performance while suppressing the increase in the differential pressure of water flow.

### Example 3

An increase in the differential pressure of water flow by providing a mixed grain size layer in which an ion exchange resin of large grain size and an ion exchange resin of small grain size are mixed was investigated. A cylindrical column with a diameter of 5 cm and a length of 5 cm was prepared, and permeated water obtained by permeating raw water through two stages of reverse osmosis membrane devices was run into the column at each flow rate of 100, 140, 210 and 250 mL/h. At that time, the pressure at the inlet and the pressure at the outlet of the column were obtained, and the difference between them was taken as the differential pressure of water flow when the column was in a blank state. Next, the same column was filled with an anion exchange resin and the permeated water was passed at the same flow rate as in the blank state, and similarly the pressure at the inlet and the pressure at the outlet were obtained to obtain the pressure difference of water flow. At this time, an anion exchange resin of large grain size and an anion exchange resin of small grain size were prepared as anion exchange resins, and these were packed in the column singly or in combination. As the anion exchange resin of large grain size, AMBERJET® 4002 manufactured by DuPont was used. The grain size of this anion exchange resin of large grain size was 0.5 to 0.65 mm, and the uniformity coefficient was 1.20 or less. As the anion exchange resin of small grain size, DOWEX® 1×4 50-100 mesh anion exchange resin manufactured by DuPont was used. The grain size of this anion exchange resin of small grain size was 0.15 to 0.3 mm, and the uniformity coefficient was 1.3 or less. The mixing ratio L:S of grains of large grain size and grains of small grain size in the anion exchange resin packed in the column was 0:1, 1:1, 5:1, 10:1, 20:1 and 1:0. L:S=0:1 indicates that it is composed only of an anion exchange resin of small grain size, and L:S=1:0 indicates that it is composed only of an anion exchange resin of large grain size.

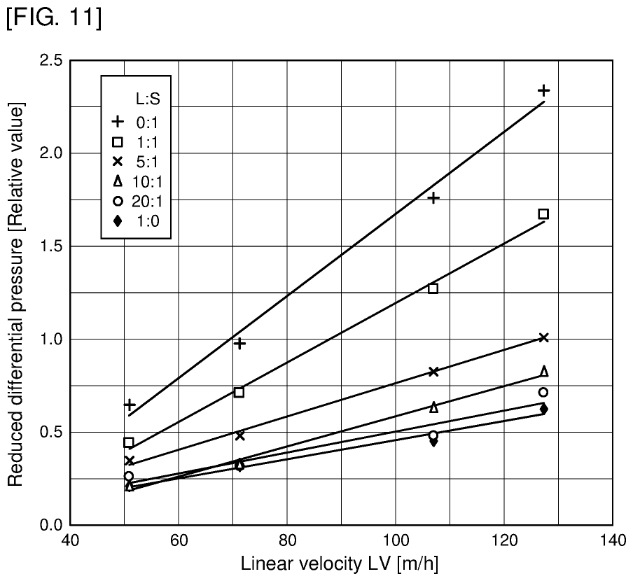

For each water flow rate in the column and for each mixing ratio in the anion exchange resin packed in the column, the differential pressure of water flow due to only the anion exchange resin was calculated by subtracting the pressure difference of water flow in the blank state from the pressure difference of water flow in the column packed with the anion exchange resin. Then, the differential pressures of water flow due to only the anion exchange resin were compared. Furthermore, in order to simulate the fact that the deionization chamber of the EDI device is composed of a cell with a thickness of 9 mm, a width of 160 mm, and a height of 280 mm, the differential pressures of water flow due to only the anion exchange resin obtained by the column were converted by calculation to the differential pressures of water flow due to only the anion exchange resin in the cell. The results are shown in FIG. 11. In FIG. 11, the differential pressure of water flow is shown as a relative value, and 1 in the relative value is the reference value, and this reference value indicates the value of the differential pressure of water flow that is generally acceptable in EDI. In FIG. 11, the horizontal axis is the linear velocity LV of the permeated water.

From FIG. 11, it can be seen that the larger the amount of anion exchange resin of large grain size, the smaller the differential pressure of water flow. When the mixing ratio L:S was within the range of 1:0 to 5:1, the increase in the differential pressure of water flow fell within a practical range even at a linear velocity of 127 m/h. When the linear velocity was 90 m/h, even if the mixing ratio L:S was 1:1, the increase in the differential pressure of water flow could be kept within a practical range.

### Example 4

In the same manner as in Example 3, an increase in the differential pressure of water flow by providing a mixed grain size layer in which an anion exchange resin of large grain size and an anion exchange resin of small grain size are mixed was examined. However, in Example 4, as the ion exchange resin of small grain size, those having a uniform grain size were used. Using the same cylindrical column as used in Example 3, the differential pressure of water flow in the blank state and the differential pressure of water flow in the case of filling with the anion exchange resin were determined in the same manner as in Example 3. As the anion exchange resin of large grain size, the same one as used in Example 2 was used. Also, DOWEX® 1×4 50-100 mesh anion exchange resin manufactured by DuPont having a grain size of 0.15 to 0.3 mm and a uniformity factor of 1.3 or less was used, and, by separating this anion exchange resin with a sieve, only grains having a grain size of about 0.3 mm were taken out. Then, the grains thus obtained were used as an anion exchange resin having a small grain size and a uniform grain size, which constitutes the mixed grain size layer. At this time, the uniformity coefficient of the anion exchange resin of small grain size constituting the mixed grain diameter layer was 1.15. The mixing ratio L:S of the grains of large grain size and the grains of small grain size in the anion exchange resin packed in the column was 0:1, 1:1, 5:1, 10:1, 20:1 and 1:0.

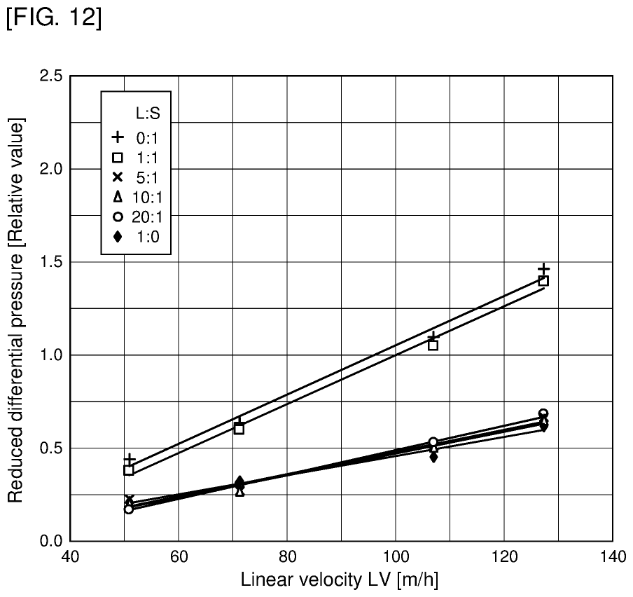

For each water flow rate in the column and for each mixing ratio in the anion exchange resin packed in the column, the differential pressure of water flow due to only the anion exchange resin was calculated by subtracting the pressure difference of water flow in the blank state from the pressure difference of water flow in the column packed with the anion exchange resin. Then, the differential pressures of water flow due to only the anion exchange resin were compared. Furthermore, in order to simulate the fact that the deionization chamber of the EDI device is composed of a cell with a thickness of 9 mm, a width of 160 mm, and a height of 280 mm, the differential pressures of water flow due to only the anion exchange resin obtained by the column were converted by calculation to the differential pressure of water flow due to only the anion exchange resin in the cell. The results are shown in FIG. 12. In FIG. 12, the differential pressure of water flow is shown as a relative value, and 1 in the relative value is the reference value, and this reference value indicates the value of the differential pressure of water flow that is generally acceptable in EDI. In FIG. 12, the horizontal axis is the linear velocity LV of the permeated water.

From FIG. 12, it was found that the differential pressure of water flow can be further reduced by using an ion exchange resin with a uniform grain size as the ion exchange resin of small grain size constituting the mixed grain size layer. In particular, it was found that the uniformity coefficient of the ion exchange resin of small grain size is preferably 1 or more and 1.2 or less, and more preferably 1 or more and 1.15 or less. When the linear velocity was 100 m/h, even if the mixing ratio L:S was 1:1, the increase in the differential pressure of water flow could be kept within a practical range.

### REFERENCE SIGNS LIST

10 EDI device;
11 Anode;
12 Cathode;
21 Anode chamber;
22, 24 Concentration chamber;
23 Deionization chamber;
25 Cathode chamber;
26, 27 Small deionization chamber;
31, 22 Cation exchange membrane (CEM);
32, 34, 36, 37 Anion exchange membrane (AEM);
40 Reverse osmosis membrane device;
41 Reverse osmosis membrane.

1. An electrodeionization device comprising:
an anode;
a cathode; and
a deionization chamber partitioned by a pair of ion exchange membranes between the anode and the cathode, the deionization chamber being filled with an ion exchange resin, wherein
a grain size of 0.1 mm or more and 0.4 mm or less being defined as small grain size, and a grain size of more than 0.4 mm being defined as large grain size,
in the deionization chamber, a large grain size layer made of an ion exchange resin of large grain size and a mixed grain size layer in which an ion exchange resin of large grain size and an ion exchange resin of small grain size are mixed are arranged along a flow of water to be treated.

2. The electrodeionization device according to claim 1, wherein the mixed grain size layer is made of an anion exchange resin.

3. The electrodeionization device according to claim 1, wherein at least a portion of the mixed grain size layer is included within a range of 25% of a length of the deionization chamber along the flow of the water to be treated from an outlet of treated water of the deionization chamber.

4. The electrodeionization device according to claim 1, wherein at least one large grain size layer is arranged upstream of the mixed grain size layer along the flow of the water to be treated.

5. The electrodeionization device according to claim 1, wherein a total filling height of the ion exchange resin along the flow of the water to be treated in the mixed grain size layer is 20% or more and 80% or less of a length of the deionization chamber along the flow of the water to be treated.

6. The electrodeionization device according to claim 1, wherein, defining L as an apparent volume of the ion exchange resin of large grain size and S as an apparent volume of the ion exchange resin of small grain size, the ion exchange resin of large grain size and the ion exchange resin of the small grain size are mixed in the mixed grain size layer with a mixing ratio in which L:S is within a range from 1:1 to 20:1.

7. An electrodeionization device comprising:
an anode;
a cathode; and
a deionization chamber partitioned by a pair of ion exchange membranes between the anode and the cathode, the deionization chamber being filled with an ion exchange resin, wherein
a grain size of 0.1 mm or more and 0.4 mm or less being defined as small grain size, and a grain size of more than 0.4 mm being defined as large grain size,
a mixed grain size layer in which an ion exchange resin of large grain size and an ion exchange resin of the small grain size are mixed with a mixing ratio in which L:S is within a range from 1:1 to 20:1 is arranged in the deionization chamber, L being defined as an apparent volume of the ion exchange resin of large grain size, and S being defined as an apparent volume of the ion exchange resin of the small grain size, and
water to be treated containing boron is supplied to the deionization chamber to remove boron from the water to be treated.

8. The electrodeionization device according to claim 7, wherein the mixed grain size layer is made of an anion exchange resin.

9. The electrodeionization device according to claim 1, wherein the deionization chamber is provided with an intermediate ion exchange membrane positioned between the pair of ion exchange membranes, and is partitioned into a first small deionization chamber and a second small deionization chamber by the intermediate ion exchange membrane, and the first small deionization chamber and the second small deionization chamber are in communication with each other so that the water to be treated is supplied to one small deionization chamber of the first small desalting chamber and the second small deionization chamber and water flowing out of the one small desalting chamber is supplied to the other small deionization chamber.

10. The electrodeionization device according to claim 9, wherein, of the first small deionization chamber and the second small deionization chamber, a small deionization chamber closer to the anode is filled with an anion exchange resin, and a part of a small deionization chamber closer to the cathode is filled with cation exchange resin.

11. A method for producing deionized water, comprising:
passing water to be treated through a deionization chamber which is partitioned by a pair of ion exchange membranes and arranged between an anode and a cathode while applying a DC voltage between the anode and the cathode, wherein
a grain size of 0.1 mm or more and 0.4 mm or less being defined as small grain size, and a grain size of more than 0.4 mm being defined as large grain size,
in the deionization chamber, the water to be treated is passed through both a large grain size layer made of an ion exchange resin of the large grain size and a mixed grain size layer in which an ion exchange resin of large grain size and an ion exchange resin of small grain size are mixed.

12. The method for producing deionized water according to claim 11, wherein the water to be treated is passed through at least one of the large grain size layer made of an anion exchange resin and the mixed grain size layer made of an anion exchange resin.

13. A method for producing deionized water, comprising:
passing water to be treated containing boron through a deionization chamber which is partitioned by a pair of ion exchange membranes and arranged between an anode and a cathode while applying a DC voltage between the anode and the cathode, wherein
a grain size of 0.1 mm or more and 0.4 mm or less being defined as small grain size, and a grain size of more than 0.4 mm being defined as large grain size,
in the deionization chamber, the water to be treated is passed through a mixed grain size layer in which an ion exchange resin of large grain size and an ion exchange resin of the small grain size are mixed with a mixing ratio in which L:S is within a range from 1:1 to 20:1, to remove boron in the water to be treated, L being defined as an apparent volume of the ion exchange resin of large grain size, and S being defined as an apparent volume of the ion exchange resin of the small grain size.

14. The electrodeionization device according to claim 1, at least one large grain size layer is made of an anion exchange resin.

15. The electrodeionization device according to claim 2, at least one large grain size layer is made of an anion exchange resin.

16. The electrodeionization device according to claim 2, wherein at least a portion of the mixed grain size layer is included within a range of 25% of a length of the deionization chamber along the flow of the water to be treated from an outlet of treated water of the deionization chamber.

17. The electrodeionization device according to claim 7, wherein the deionization chamber is provided with an intermediate ion exchange membrane positioned between the pair of ion exchange membranes, and is partitioned into a first small deionization chamber and a second small deionization chamber by the intermediate ion exchange membrane, and the first small deionization chamber and the second small deionization chamber are in communication with each other so that the water to be treated is supplied to one small deionization chamber of the first small desalting chamber and the second small deionization chamber and water flowing out of the one small desalting chamber is supplied to the other small deionization chamber.

18. The electrodeionization device according to claim 17, wherein, of the first small deionization chamber and the second small deionization chamber, a small deionization chamber closer to the anode is filled with an anion exchange resin, and a part of a small deionization chamber closer to the cathode is filled with cation exchange resin.
